(19) United States
(12) Patent Application Publication
(10) Pub. No.: US 2015/0152829 A1
(43) Pub. Date: Jun. 4, 2015

(54) LOW-PRESSURE CIRCUIT FOR A FUEL INJECTION SYSTEM, FUEL INJECTION SYSTEM AND METHOD FOR OPERATING A FUEL INJECTION SYSTEM

(71) Applicant: Robert Bosch GmbH, Stuttgart (DE)

(72) Inventors: Thomas Koenig, Ditzingen (DE); Francesco Lucarelli, Stuttgart (DE)

(21) Appl. No.: 14/414,354

(22) PCT Filed: May 31, 2013
(86) PCT No.: PCT/EP2013/061304

§ 371 Date: Jan. 12, 2015

(30) Foreign Application Priority Data
Jul. 11, 2012 (DE) 102012212062.9

(51) Int. Cl. F02M 63/02

(52) U.S. Cl. CPC F02M 63/0265; F02M 63/0275

(57) ABSTRACT

The invention relates to a low-pressure circuit for a fuel injection system, in particular for a common-rail injection system, comprising a fuel tank (1) and a pre-feed pump (2), by means of which fuel from the fuel tank (1) can be suctioned and fed to a working chamber (4) of a high-pressure pump (5) via a fuel line (3), wherein the working chamber (4) is connected to a return line via shaft bearings. According to the invention at least two throttles (9, 10) are provided for connecting the working chamber (4) with the return (8), which throttles are in each case connected parallel to the shaft bearings (6, 7) and/or can be connected by means of a valve (11). The invention further relates to a fuel injection system comprising such a low-pressure circuit and to a method for operating a fuel injection system.

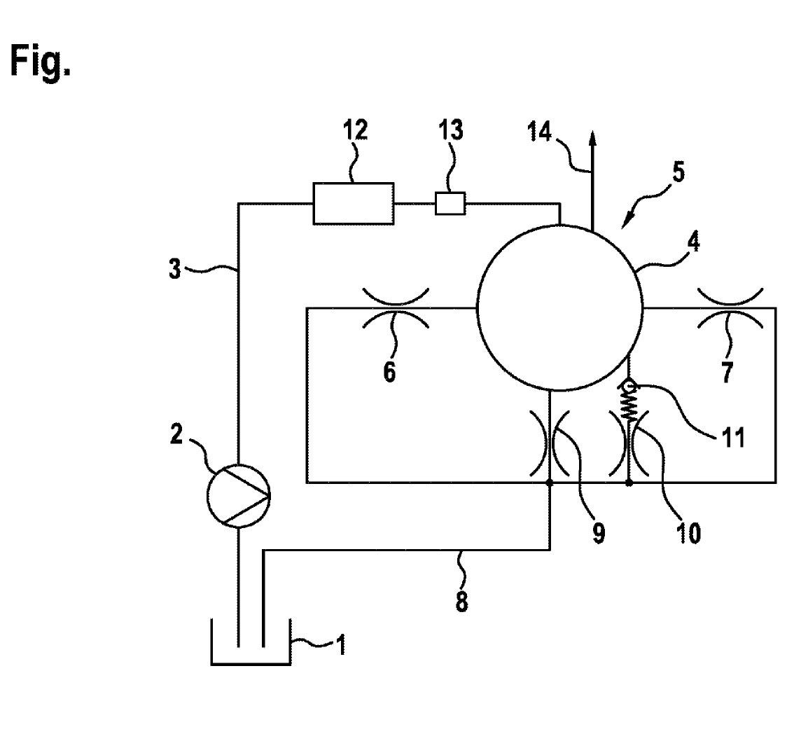

### BACKGROUND OF THE INVENTION

The invention relates to a low-pressure circuit for a fuel injection system. The invention also relates to a fuel injection system having a low-pressure circuit, and to a method for operating a fuel injection system.

DE 10 2006 018 702 A1 has disclosed a fuel high-pressure delivery device for an internal combustion engine, said fuel high-pressure delivery device comprising a high-pressure pump and a low-pressure flow path. The low-pressure flow path leads from a fuel inlet of the fuel high-pressure delivery device to a receiving chamber for a drive shaft of the high-pressure pump, and onward to at least one inlet valve of the high-pressure pump. Furthermore, a return flow path is provided for returning leakage and/or lubricating fuel, which return flow path is connected to the receiving chamber of the high-pressure pump via shaft bearings for the rotatable mounting of the drive shaft. The return flow path issues into the low-pressure flow path, wherein at least one throttle for the targeted setting of the returned fuel flow rate may be arranged in the return flow path. It is the intention for the efficiency of the fuel high-pressure delivery device to be improved in this way.

Furthermore, low-pressure circuits are known which provide an overflow valve instead of a throttle in order to set the returned fuel flow rate. The throttle has the disadvantage in relation to an overflow valve that an increase in inlet pressure is not associated with a significant increase in throttle throughflow, such that there is the risk of the inlet pressure rising to inadmissibly high values. The dependency between throttle throughflow and pressure difference in the inlet and return region can be represented by the following formula:

$$Q = μ \cdot A \cdot \sqrt{\frac{2}{ρ} Δ p}$$

That is to say that, in critical operating situations, for example in the presence of elevated pressure or elevated temperature in the drive unit chamber of the high-pressure pump, the cooling flow rate cannot be increased to the desired extent by means of the throttle. This can result in a deterioration in fuel lubrication capability and/or an increased risk of wear. For example, the lubricating film between a roller of a tappet assembly and a support element for the rotatable mounting of the roller may decrease to a critical value, resulting in premature wear of the tappet assembly and thus failure of the delivery device.

### SUMMARY OF THE INVENTION

The present invention is therefore based on the object of specifying a low-pressure circuit for a fuel injection system and a fuel injection system having at least one throttle arranged in a return line, which throttle permits setting of the returned fuel flow rate in a simple manner and simultaneously does not exhibit the disadvantages mentioned above. It is also sought to specify a method for operating a fuel injection system of said type.

The proposed low-pressure circuit for a fuel injection system, in particular a common-rail injection system, comprises a fuel tank and a predelivery pump by means of which fuel can be drawn in from the fuel tank and supplied via a fuel line to a drive unit chamber of a high-pressure pump. In this case, the drive unit chamber is connected via shaft bearings to a return line. According to the invention, furthermore, for connecting the drive unit chamber to the return line, at least two throttles are provided which are each connected, and/or connectable by means of a valve, in parallel with the shaft bearings. Whereas base leakage for cooling and/or lubrication of the high-pressure pump is ensured by means of the shaft bearings, the setting of the required leakage flow rate is performed by way of the throttles, which are connected or connectable in parallel, of the low-pressure circuit according to the invention. A valve is preferably provided by means of which at least one throttle can be activated or deactivated such that a further flow path, which connects the drive unit chamber to the return line and which bypasses the shaft bearings, can be opened up or closed off. This assumes that at least one throttle—without a valve positioned upstream—forms a first flow path which connects the drive unit chamber to the return line and which bypasses the shaft bearings, which first flow path ensures the required leakage flow rate during normal operation of the high-pressure pump. Then, an increase of the leakage flow rate and thus improved cooling and/or lubrication of the high-pressure pump can be realized as required by means of the at least one further activatable throttle, said increase being dependent on the throttle cross section and the respectively prevailing pressure. The throttle cross section should preferably be selected such that, firstly, a considerable improvement in the cooling and/or lubrication of the high-pressure pump is attained, and secondly, the flow rate balance of the low-pressure circuit is not impaired. Accordingly, the maximum flow rate provided by the predelivery pump must not be exceeded.

The advantage of the invention can be seen in particular in the fact that an increase in the leakage flow rate is realized only when required, in particular in the event of a brief very high load on the high-pressure pump. For example, in critical operating situations, the pressure and/or the temperature in the drive unit chamber of the high-pressure pump may rise above a predefined threshold value, such that the provision of an additional cooling and/or lubricating flow rate is necessary. The provision of the additional cooling and/or lubricating flow rate is then ensured by means of the at least one further throttle which is switchable in parallel with the shaft bearings by means of a valve, said throttle then being briefly activated. An increase in the leakage flow rate which serves for cooling and/or lubrication is then briefly effected, whereas the valve is closed, and the further throttle deactivated, during normal operation of the high-pressure pump, such that the returned leakage flow rate can be reduced to a minimum. An increase in the efficiency of the system and a reduction in CO₂ emissions can be achieved in this way.

In a preferred embodiment of the invention, at least two throttles are provided, of which at least one throttle is connected by means of a valve to the drive unit chamber of the high-pressure pump, and is accordingly activatable or deactivatable.

In a further preferred embodiment of the invention, the valve is a check valve. It is accordingly a passively actuable valve which opens when a predefined opening pressure is exceeded. Such valves are particularly simple and inexpensive to produce, such that the production costs of a low-pressure circuit according to the invention are scarcely increased. The valve in the form of a check valve opens when a certain threshold pressure is exceeded in the drive unit chamber of the high-pressure pump. The opening pressure of the valve is advantageously selected so as to lie below the maximum admissible pressure in the drive unit chamber of the high-pressure pump. The opening pressure may for example lie 1 bar below the maximum admissible pressure in the drive unit chamber.

Furthermore, the valve may also be in the form of an actively actuable valve which is connected to a control unit. The control unit is furthermore preferably connected to at least one sensor for detecting a pressure and/or a temperature in the low-pressure circuit, such that the valve is opened in the event of a preset threshold value being exceeded.

It is furthermore preferable for the predelivery pump to be a regulated electric fuel pump. The use of a regulated electric fuel pump as a predelivery pump eliminates the need to use a metering unit and/or an overflow valve. Since concepts with an overflow valve generally, in particular in the case of a predefined interior pressure and a steep characteristic curve of the overflow valve, have the disadvantage that large leakage flow rates must be returned, the omission of the overflow valve is basically desirable.

At least one fuel filter is advantageously arranged between the predelivery pump and the high-pressure pump. The fuel filter serves for protecting the high-pressure pump against damaging particles contained in the fuel. Alternatively or in addition, at least one sensor, preferably a pressure and/or temperature sensor, may be arranged between the predelivery pump and the high-pressure pump in order to detect the fuel pressure and/or the fuel temperature in the low-pressure circuit, in particular in the fuel line and/or in the drive unit chamber of the high-pressure pump. The values detected by means of the sensor may serve for the regulation of a predelivery pump designed as an electric fuel pump, and/or for the actuation of a valve by means of which at least one throttle arranged in a return line can be activated or deactivated.

It is furthermore advantageous for the fuel line to be connected via the drive unit chamber to an inlet of the high-pressure pump. This means that the entire fuel flow delivered by means of the predelivery pump passes firstly into the drive unit chamber of the high-pressure pump and is supplied from there as a delivery flow to the inlet of the high-pressure pump, or is discharged, as a leakage flow which serves for the cooling and/or lubrication of the high-pressure pump, via the shaft bearings and the throttles that are connected or connectable in parallel.

The fuel injection system, which is also proposed with regard to achieving the object stated in the introduction, for injecting fuel into the combustion chamber of an internal combustion engine has a low-pressure circuit according to the invention. The proposed fuel injection system is accordingly characterized by improved efficiency and a reduction in CO₂ emissions. Furthermore, the load on the high-pressure pump is reduced because inadmissibly high pressure and/or temperature increases in the drive unit chamber of the high-pressure pump are prevented. The service life of the high-pressure pump is thus lengthened.

Finally, a method for operating a fuel injection system according to the invention is proposed, in which the fuel pressure and/or the fuel temperature in the low-pressure circuit, preferably in the fuel line and/or in the drive unit chamber of the high-pressure pump, is detected, and in the event of a predefined threshold value being exceeded, the delivery rate of the predelivery pump is increased until the valve is opened, such that the throttle arranged downstream of the valve is activated. The leakage flow rate which serves for cooling and/or lubrication of the high-pressure pump can accordingly be increased by means of an activatable throttle, such that an inadmissibly high pressure or an inadmissibly high temperature in the drive unit chamber of the high-pressure pump are prevented in an effective manner. Accordingly, in critical operating situations, it is possible for the cooling and/or lubrication of the high-pressure pump to be improved, such that damage to the high-pressure pump is counteracted.

### BRIEF DESCRIPTION OF THE DRAWING

A preferred embodiment of the invention will be explained in more detail below on the basis of the appended drawing.

The single drawing FIGURE shows a schematic illustration of a low-pressure circuit according to the invention of a fuel injection system.

### DETAILED DESCRIPTION

The schematically illustrated low-pressure circuit according to the invention comprises a predelivery pump 2 which is designed as a regulable electric fuel pump and by means of which fuel can be supplied from a fuel tank 1 via a fuel line 3 to a high-pressure pump 5. In this case, the fuel line 3 issues into a drive unit chamber 4 of the high-pressure pump 5, in which the fuel flow rate that is supplied is divided into a delivery flow rate and a cooling and/or lubricating flow rate. The delivery flow rate is supplied via an inlet 14 to a high-pressure region (not illustrated) of the high-pressure pump 5, whereas the cooling and/or lubricating flow rate passes via a return line 8 back into the fuel tank 1. The return line 8 is connected to the drive unit chamber 4 via shaft bearings 6, 7 of the high-pressure pump 5. Furthermore, a throttle 9 is provided which is connected in parallel with the shaft bearings 6, 7 and which connects the return line 8 to the drive unit chamber 4 of the high-pressure pump 5. The shaft bearings 6, 7 and the throttle 9 which is connected in parallel ensure a minimum cooling flow rate and/or minimum lubrication flow rate.

Furthermore, the low-pressure circuit according to the invention which is schematically illustrated in the FIGURE has a further throttle 10 which is likewise connectable in parallel with the shaft bearings 6, 7 by means of a valve 11. In the present case, the valve 11 is in the form of a simple check valve, the opening pressure of which lies below the maximum admissible pressure in the drive unit chamber 4 of the high-pressure pump 5. If the pressure in the drive unit chamber 4 of the high-pressure pump rises above the maximum admissible value, the valve 11 opens, such that an additional cooling and/or lubricating flow rate is discharged from the drive unit chamber 4 via the throttle 10. The drive unit chamber 4 is thus relieved of pressure, and at the same time, the cooling and/or lubrication of the high-pressure pump 5 is improved.

The low-pressure circuit schematically illustrated in the FIGURE also has a fuel filter 12 and a sensor 13 between the predelivery pump 2 and the high-pressure pump 5, wherein said sensor is in the present case a temperature sensor. The sensor 13 serves for the regulation of the electric fuel pump or predelivery pump 2. If the temperature detected by the sensor 13 exceeds a particular threshold value, the delivery rate of the predelivery pump 2 is increased until the pressure in the drive unit chamber 4 of the high-pressure pump 5 rises to such an extent that the valve 11 opens. The fuel flow rate that is now additionally returned via the throttle 10 then effects improved cooling of the high-pressure pump, and thus a reduction of the temperature.

1. A low-pressure circuit for a fuel injection system, comprising a fuel tank (1) and a predelivery pump (2) by means of which fuel can be drawn in from the fuel tank (1) and supplied via a fuel line (3) to a drive unit chamber (4) of a high-pressure pump (5), wherein the drive unit chamber (4) is connected via shaft bearings (6, 7) to a return line (8),
characterized in that, furthermore, for connecting the drive unit chamber (4) to the return line (8), at least two throttles (9, 10) are provided which are each connected, and/or connectable by means of a valve (11), in parallel with the shaft bearings (6, 7).

2. The low-pressure circuit as claimed in claim 1, characterized in that the valve (11) is a check valve.

3. The low-pressure circuit as claimed in claim 1, characterized in that the predelivery pump (2) is a regulated electric fuel pump.

4. The low-pressure circuit as claimed in claim 1, characterized in that at least one of a fuel filter (12) and/or and at least one sensor (13) is or are is arranged between the predelivery pump (2) and the high-pressure pump (5).

5. The low-pressure circuit as claimed in claim 1, characterized in that the fuel line (3) is connected via the drive unit chamber (4) to an inlet (14) of the high-pressure pump (5).

6. A fuel injection system for injecting fuel into the combustion chamber of an internal combustion engine, having a low-pressure circuit as claimed in claim 1.

7. A method for operating a fuel injection system having the features of claim 6, characterized in that at least one of the fuel pressure and the fuel temperature in the low-pressure circuit is detected, and in the event of a predefined threshold value being exceeded, a delivery rate of the predelivery pump (2) is increased until the valve (11) is opened, such that a one of the throttles (10) arranged downstream of the valve (11) is activated.

8. A method for operating a fuel injection system having the features of claim 6, characterized in that at least one of the fuel pressure and the fuel temperature in at least one of the fuel line (3) and the drive unit chamber (4) is detected, and in the event of a predefined threshold value being exceeded, the delivery rate of the predelivery pump (2) is increased until the valve (11) is opened, such that a one of the throttles (10) arranged downstream of the valve (11) is activated.

9. A method for operating a fuel injection system having the features of claim 6, characterized in that the fuel pressure and the fuel temperature in in the fuel line (3) and in the drive unit chamber (4) are is detected, and in the event of a predefined threshold value being exceeded, the delivery rate of the predelivery pump (2) is increased until the valve (11) is opened, such that a one of the throttles (10) arranged downstream of the valve (11) is activated.

10. The low-pressure circuit as claimed in claim 1, characterized in that a pressure and/or temperature sensor is or are arranged between the predelivery pump (2) and the high-pressure pump (5).

11. A low-pressure circuit for a fuel injection system, in particular a common-rail injection system, comprising a fuel tank (1) and a predelivery pump (2) by means of which fuel can be drawn in from the fuel tank (1) and supplied via a fuel line (3) to a drive unit chamber (4) of a high-pressure pump (5), wherein the drive unit chamber (4) is connected via shaft bearings (6, 7) to a return line (8),
characterized in that, furthermore, for connecting the drive unit chamber (4) to the return line (8), at least two throttles (9, 10) are provided which are each connected in parallel with the shaft bearings (6, 7).

12. A low-pressure circuit for a fuel injection system, in particular a common-rail injection system, comprising a fuel tank (1) and a predelivery pump (2) by means of which fuel can be drawn in from the fuel tank (1) and supplied via a fuel line (3) to a drive unit chamber (4) of a high-pressure pump (5), wherein the drive unit chamber (4) is connected via shaft bearings (6, 7) to a return line (8),
characterized in that, furthermore, for connecting the drive unit chamber (4) to the return line (8), at least two throttles (9, 10) are provided which are each connectable by means of a valve (11) in parallel with the shaft bearings (6, 7).
